(19) United States
(12) Patent Application Publication
(10) Pub. No.: US 2014/0044266 A1
(43) Pub. Date: Feb. 13, 2014

(54) REAL-TIME NOISE REDUCTION APPARATUS FOR RADIO MONITORING SYSTEM

(71) Applicant: ELECTRONICS AND TELECOMMUNICATIONS RESEARCH INSTITUTE, Daejeon (KR)

(72) Inventors: Sang Tae KIM, Daejeon (KR); Yong Seok CHOI, Daejeon (KR); Gwang Moon PARK, Daejeon (KR); Seong Yun LEE, Daejeon (KR); Haeng Sook RO, Daejeon (KR); Mi Kyung SUK, Daejeon (KR)

(21) Appl. No.: 13/922,643

(22) Filed: Jun. 20, 2013

(30) Foreign Application Priority Data
Aug. 10, 2012 (KR) 10-2012-0088062

(51) Int. Cl. G10K 11/00

(52) U.S. Cl. CPC G10K 11/002
USPC 381/1

(57) ABSTRACT

The present invention provides a real-time noise reduction apparatus for a radio monitoring system, including a dual channel digitizing unit configured to convert signals, subject to frequency down-conversion and inputted to two channels, into digital signals and a Digital Signal Processor (DSP) configured to reduce noise from time sample regions of the signals, received from the dual channel digitizing unit, in a time domain using a correlation method between samples through the delayed feedback means.

### CROSS-REFERENCES TO RELATED APPLICATIONS

The present application claims priority under 35 U.S.C 119(a) to Korean Application No. 10-2012-0088062, filed on Aug. 10, 2012, in the Korean Intellectual Property Office, which is incorporated herein by reference in its entirety set forth in full.

### BACKGROUND

Exemplary embodiments of the present invention relate to real-time noise reduction apparatuses for radio monitoring systems, and more particularly, to real-time noise reduction apparatuses for radio monitoring systems, which are capable of improving the reception sensitivity of a Radio Frequency (RF) reception apparatus for radio measurement using quantization sampling technology including multiple channels and noise reduction technology using time domain correlation processing.

In radio measurement and radio monitoring technology fields, the technical performance of an RF reception apparatus is limited by radio reception sensitivity for a low signal level and a dynamic range for a high signal level. In order to secure a dynamic range for a high signal, there are being proposed post-processing techniques for overcoming the limits of band-limited Gaussian-supplementary noise that are accompanied by a signal amplification and attenuation apparatus and RF frequency conversion means.

In general, a noise reduction method in the frequency domain includes lots of data collection time and post-processing processes. This is because in this noise reduction method, conversion into the frequency domain is performed, a frequency bin for signal data can be handled in the frequency domain, and thus a noise threshold can be analyzed.

This frequency-based noise reduction method facilitates an analysis of the frequency domain, such as an analysis of a cross spectrum using repeatedly collected samples or a spectral feature correlation subject to frequency conversion from a plurality of RF reception channels.

In this common noise reduction method, a method for reducing a resolution bandwidth according to digital Fast Fourier Transform (FFT) using the collection of lots of digital sample data or a frequency conversion-based SPectral Subtraction (SPS) method using a post-processing process.

However, the aforementioned method can be readily used in an analysis of the frequency domain characteristics of a signal, such as spurious measurement, but is problematic in that it is insufficient for an analysis of a signal in the time domain, such as frequency offset measurement.

Accordingly, there is a need for a method easily applicable to sampling signal channels that are collected in real time in the time domain.

Background technology related to the present invention includes Korean Patent Laid-Open Publication No. 10-2012-0011168 (Feb. 7, 2012) entitled ‘SYSTEM AND METHOD FOR ELIMINATING NOISES IN-BAND’.

### SUMMARY

An embodiment of the present invention relates to a real-time noise reduction apparatus for a radio monitoring system, which improves the reception sensitivity of an RF reception apparatus for radio measurement using quantization sampling technology including multiple channels and noise reduction technology using time domain correlation processing.

In one embodiment, a real-time noise reduction apparatus for a radio monitoring system includes a dual channel digitizing unit configured to convert signals, subject to frequency down-conversion and inputted to two channels, into digital signals and a Digital Signal Processor (DSP) configured to reduce noise in a time domain using a correlation between samples through feedback, from time sample regions, of the signals received from the dual channel digitizing unit.

The dual channel digitizing unit of the present invention includes a dual channel digitizer configured to convert the signals, received from the two channels, into the digital signals and a clock generation unit configured to provide a sampling clock to the dual channel digitizer.

The clock generation unit of the present invention generates the sampling clock variably in response to the signals inputted to the two channels.

The dual channel digitizer of the present invention further includes a switching unit configured to enable a reference noise signal level, randomly generated from the two channels, to be used as a reference noise channel for a correlation comparison.

The DSP of the present invention includes a noise reduction algorithm processing unit for reducing noise from the signals inputted to the two channels using a time recursive noise reduction algorithm.

The noise reduction algorithm processing unit of the present invention includes a real-time correlation comparison unit configured to generate a correlation comparison output from time domain samples that are consecutively inputted to the two channels temporally, correlation determination delay compensation units configured to compensate for the delay of the time domain samples in relation to the processing time of the signals inputted to the two channels, and a recursive noise reduction algorithm unit configured to perform the time recursive noise reduction algorithm for reducing noise by feeding back an output value obtained from a previous time domain sample of the time domain samples.

The recursive noise reduction algorithm unit of the present invention performs the time recursive noise reduction algorithm on the time domain samples when a correlation comparison value between the two channels is a threshold parameter or higher as a result of calculating a correlation coefficient between the two channels.

The recursive noise reduction algorithm unit of the present invention includes calculates a correlation coefficient between the two channels and transfers one of values inputted to the two channels or the mean of the values inputted to the two channels when a correlation comparison value between the two channels is less than a set threshold parameter and equal to 0 or higher.

The real-time noise reduction apparatus of the present invention further includes a dual channel frequency down-converter configured to perform frequency down-conversion on the signals inputted to the two channels into signals of a base band so that the signals inputted to the two channels are able to be processed by the dual channel digitizing unit.

The real-time noise reduction apparatus of the present invention further includes a single channel frequency down-converter configured to perform frequency down-conversion on signals received through a single channel from antennas and a channel correction unit configured to convert the signals inputted to the single channel frequency down-converter into signals for the two channels, synchronize phases of the signals between the two channels, match levels of the signals with each other between the two channels, and input resulting signals to the dual channel digitizer.

### BRIEF DESCRIPTION OF THE DRAWINGS

The above and other aspects, features and other advantages will be more clearly understood from the following detailed description taken in conjunction with the accompanying drawings, in which:

FIG. 1 is a block diagram showing a real-time noise reduction apparatus for a radio monitoring system using a dual channel in accordance with an embodiment of the present invention;

FIG. 2 is a block diagram of a dual channel digitizing unit and a DSP shown in FIG. 1;

FIG. 3 shows a concept of time domain recursive noise reduction technology based on a real-time sample correlation performed by the DSP of FIG. 1;

FIG. 4 shows an embodiment of time-frequency domain analysis extension structure using time domain noise reduction technology performed by the DSP of FIG. 1;

FIG. 5 is a block diagram showing a real-time noise reduction apparatus for a radio monitoring system using a single channel in accordance with another embodiment of the present invention; and

FIG. 6 is a diagram showing results of the operation simulations of the real-time noise reduction apparatus for a radio monitoring system in accordance with an embodiment of the present invention.

### DESCRIPTION OF SPECIFIC EMBODIMENTS

Hereinafter, embodiments of the present invention will be described with reference to accompanying drawings. However, the embodiments are for illustrative purposes only and are not intended to limit the scope of the invention.

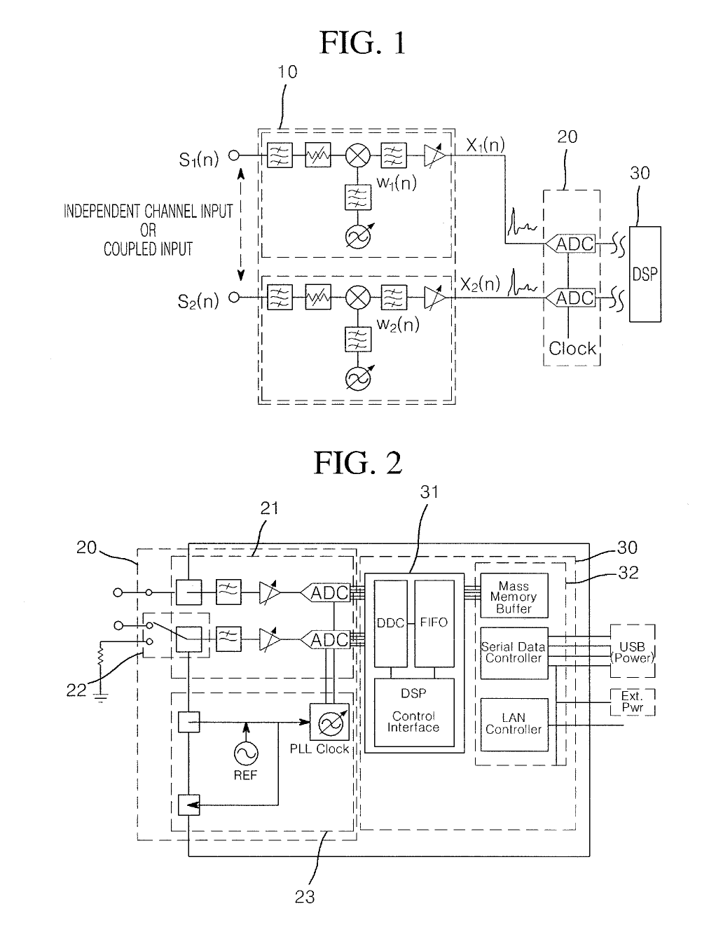

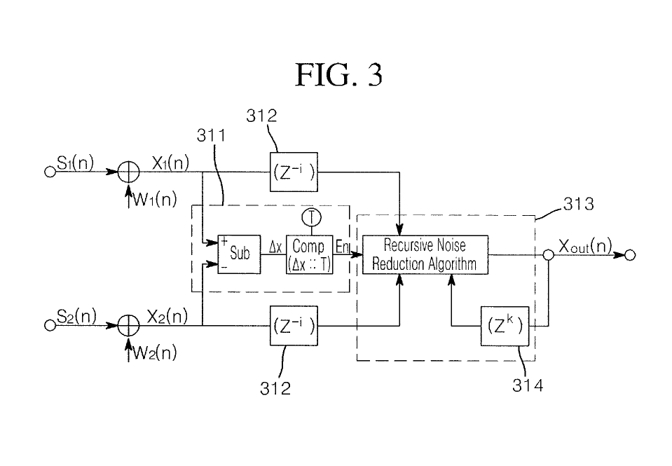

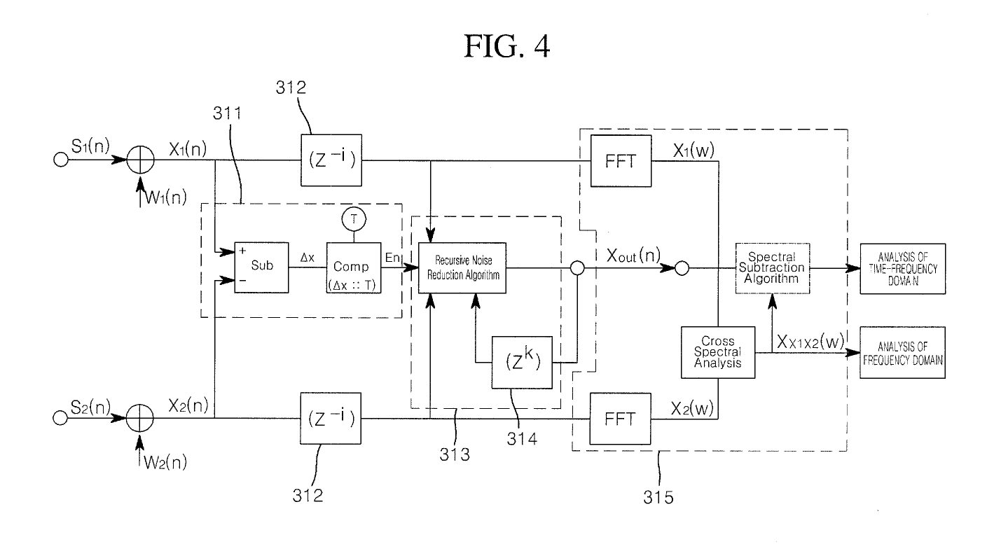

FIG. 1 is a block diagram showing a real-time noise reduction apparatus for a radio monitoring system using a dual channel in accordance with an embodiment of the present invention, FIG. 2 is a block diagram of a dual channel digitizing unit and a DSP shown in FIG. 1, FIG. 3 shows a concept of time domain recursive noise reduction technology based on a real-time sample correlation performed by the DSP of FIG. 1, and FIG. 4 shows an embodiment of time-frequency domain analysis extension structure using time domain noise reduction technology performed by the DSP of FIG. 1.

The real-time noise reduction apparatus for a radio monitoring system in accordance with the embodiment of the present invention forms a target input signal into signals for two channels using a frequency down-converter and digitizes the signals of the two channels or digitizes a signal from one channel into signals for two channels in a process of performing frequency down-conversion on the signal of the one channel and then reduces noise in the time domain using a sample correlation based on feedback from the time sample region of the digital signals.

In this specification, a real-time noise reduction apparatus for a radio monitoring system using two channels and a real-time noise reduction apparatus for a radio monitoring system using a single channel according to two embodiments are described below.

The real-time noise reduction apparatus for a radio monitoring system using two channels in accordance with an embodiment of the present invention includes a dual channel frequency down-converter 10, a dual channel digitizing unit 20, and a Digital Signal Processor (DSP) 30 as shown in FIG. 1.

The dual channel frequency down-converter 10 converts RF signals received through a plurality of antennas or a single antenna into a base band signal region that can be processed by a dual channel digitizer 21 included in the dual channel digitizing unit 20.

The dual channel frequency down-converter 10 includes an RF band filter having a noise-supplementary characteristic, a signal attenuator, a frequency mixer, a frequency synthesizer (i.e., an LO generator), an Intermediate Frequency (IF) filter, a signal amplification device, and so on.

In particular, the dual channel frequency down-converter 10 includes two frequency down-converters for performing frequency down-conversion on the same target input signal so that the same target input signal corresponds to two channels. Thus, a correlation feature between two channels from the IF component of the same target signal can be used.

For reference, the RF signals including information cannot be directly converted into data for signal processing by a digitizer (i.e., an Analog-Digital Converter (ADC)) due to its frequency characteristics. For this reason, the frequency spectra of the RF signals must be converted into an IF by way of down-conversion into a low frequency band that can be processed by the dual channel digitizer 21 using a superheterodyne receiver structure having 2 to 3 stages.

Here, the RF signals experience the dual channel frequency down-converter 10 including a signal-combined output using a plurality of independent antenna inputs or a single antenna input. In this case, after passing through the dual channel frequency down-converter 10, the RF signals are deteriorated due to the matching of the signals and supplementary and independent noise characteristics generated in a band-limited filter, and a frequency mixer.

That is, the Signal to Noise Ratio (SNR) of the RF signals S1(n) and S2(n) is deteriorated due to supplementary noise and unnecessary signals ω(n) that are accompanied by frequency conversion and signal matching in an RF reception path (i.e., the attenuation and amplification of the RF signals). Here, the noise component ω(n) added in each RF reception channel has a constant and independent distribution characteristic.

Accordingly, the real-time noise reduction apparatus for a radio monitoring system in accordance with the embodiment of the present invention includes two independent channels and improves signal-noise performance accompanied in the RF reception path including the two channels.

The dual channel digitizing unit 20 digitizes the two analog signals received from the dual channel frequency down-converter 10. The dual channel digitizing unit 20 includes the dual channel digitizer 21, a clock generation unit 23, and a switching unit 22.

The dual channel digitizer 21 corrects the levels of the two analog signals between the channels by way of variable amplification, filtering, and dithering and transfers the digital signals of the two channels to a noise reduction algorithm processing unit 31.

That is, the dual channel digitizer 21 includes two digitizers that are synchronized with each other in order to convert the two analog signals into the digital signals capable of being subject to digital signal processing because the dual channel frequency down-converter 10 includes two outputs, that is, the two analog signals of an IF.

The switching unit 22 enables the levels of the noise signals, added in the dual channel frequency down-converter 10, and a reference noise signal, randomly generated through a matching termination circuit configuration, to be used as the reference noise channel for correlation comparison.

The clock generation unit 23 generates a specific sampling frequency clock in the dual channel digitizer 21. Here, the dual channel digitizer 21 collects the digital values of the analog signals of having an IF at a specific time domain sample time. In order to precisely represent the analog signals, the cycle of sampling (i.e., an inverse number of a sampling frequency) in the dual channel digitizer 21 includes an IF or a specific sampling frequency according to a signal bandwidth.

To this end, the clock generation unit 23 variably provides a sampling clock so that the sampling clock is suitable for an IF signal characteristic, such as an IF or a bandwidth, using an external clock, an internal reference clock, and a PLL synthesizer. Accordingly, the clock generation unit 23 can be used universally when the two channels have different frequencies or irrespective of frequencies inputted to the two channels.

The DSP 30 reduces noise in the time domain by way of sample correlation through feedback, from the time sample regions, of the digital signals received from the dual channel digitizing unit 20.

The DSP 30 reduces noise included in the signals received from the dual channel digitizing unit 20 using time domain recursive noise reduction technology based on real-time correlation and comparison and sample correlation. The DSP 30 includes the noise reduction algorithm processing unit 31 and a sample transmission unit 32.

The noise reduction algorithm processing unit 31 reduces noise included in the digital signals, generated from the dual channel digitizer 21, using a noise reduction algorithm shown in FIGS. 3 and 4.

The noise reduction algorithm processing unit 31 includes correlation determination delay compensation units 312, a real-time correlation comparison unit 311, and a recursive noise reduction algorithm unit 313 as shown in FIG. 3.

The real-time correlation comparison unit 311 generates a correlation comparison output from time domain samples that are consecutively received in real time.

Each of the correlation determination delay compensation units 312 includes a buffer circuit and compensates for the delay of some of the time domain samples over a processing time. The correlation determination delay compensation unit 312 performs statistical correlation processing between delayed some samples of a signal, inputted to the buffer circuit in relation to a recursive signal, and a current input sample by applying specific samples of sampling data in the time domain to the noise reduction algorithm.

The recursive noise reduction algorithm unit 313 performs a recursive noise reduction algorithm on an output value obtained by processing samples in a previous time domain using a feedback comparison circuit in order to reduce noise.

The recursive noise reduction algorithm unit 313 includes an output sample feedback buffer 314 in order to apply the recursive noise reduction algorithm. That is, in order to apply the recursive noise reduction algorithm, the output signal samples are fed back and then applied to a circuit for determining and reducing noise in the signal samples.

The recursive noise reduction algorithm is described in detail below.

Signal component energy in the frequency domain is modeled into a reception component including signal spectrum bins having a noise threshold or higher within a noise spectrum. Signal component energy in the time domain includes a sine function of signal component frequencies including noise power.

Accordingly, a signal level value necessary in the RF reception channel model having common supplementary noise characteristics can be considered to be hidden under the estimated noise threshold of a frequency domain including noise components. In m multiple channel reception models, such as Equation 1, in the frequency domain, a signal spectrum using a correlation can be extracted from a non-correlation feature between the channels of noise spectrum components.

Yᵢ(m,fₖ)=sᵢ(m,fₖ)+Nᵢ(m,fₖ) [Equation 1]

Noise reduction in the time domain is applied to noise and interference suppression technology using a code correlation of collected sample groups, such as Code Division Multiple Access (CDMA), in a special condition. In the collection of common time domain signals, however, a data smoothing method using a moving average is being proposed. In the case of the moving average, a gain is high near DC because the moving average has a low bandpass filter characteristic, and signal levels are averaged by way of the moving average of sample levels. As a result, the energy density of signal components according to energy leakage is also reduced by the average effect.

The recursive noise reduction algorithm of the present invention calculates the sample correlation value of supplementary Gaussian noise distribution channels using a digitizer construction including two or more channels, such as the dual channel digitizer 21, and applies noise reduction technology, that is, a weighted recursive average, using the characteristics of a sine function parameter in the time domain only when the sample correlation value is a specific correlation or higher in order to maintain a coherent signal characteristic between the channels.

In a common method, in the case of a noise level correlation analysis threshold or lower, reference channels x₁(t) is allocated to an output or the average of two or more multiple channels is obtained. In the case of a threshold or higher, the average of multiple channels is obtained or calculation is performed using a time recursive noise reduction algorithm from values xₒᵤₜ(t−k) an, xᵢ(t), x₂(t), . . . , for feedback mean processing using a variation characteristic between samples correlated to the sampling frequency of a previous output value.

In a primary comparison in a noise-dependent sample interval, a time domain noise reduction method for the noise-dependent sample interval is implemented by noise-dependent threshold level comparison means using Equations 2 to 4, that is, correlation calculation conditional expressions between the two channels for real-time collection samples dependent on signal levels.

T:=thresholdparameter [Equation 2]

{|x₁(t)−x₂(t)|DT}2{xₒᵤₜ=x₁(t)} [Equation 3]

{|x₁(t)−x₂(t)|>T}2{xₒᵤₜ=mean(xₒᵤₜ(t−k),x₁(t),x₂(t)} [Equation 4]

That is, after a correlation coefficient for the two quantization input channels is calculated, when a correlation value is high, that is, a correlation comparison value between the two channels in Equations 2 to 4 is close to less than a preset threshold parameter T to 0, a real-time recursive noise reduction parameter k is set to 1 or lower and thus the input value x₁(t) or x₂(t) or a mean thereof is transferred without change.

In contrast, when the correlation comparison value is low, that is, the correlation comparison value between the two channels in Equations 2 to 4 is a preset threshold parameter T or higher, it means that estimated noise-dependent energy is great. Thus, the feedback parameter k is increased and thus the recursive noise reduction algorithm is applied to corresponding samples.

Here, the correlation coefficient can be defined as a difference between the two channels in Equations 2 to 4, or a comparison correlation for a previous output value and a difference between quantization channel samples may be incorporated into the correlation coefficient for example.

This recursive noise reduction algorithm includes a modified processing algorithm using a primary average between channels, secondary statistical processing including feedback samples, and an ensemble mean processing using a bundle of collected samples.

As described above, in the noise reduction technology using a correlation feature between multi-channel time domain quantization samples according to the present invention, signal components of a low level including a plurality of signal components can be detected using the noise reduction algorithm through correlation processing between m reception channels.

Furthermore, in accordance with the noise reduction technology based on a time domain correlation between quantized reception channels according to the present invention, an independent component having a random noise characteristic included in received sample data is suppressed by the processing of an average or a minimum value using primary statistical processing or the recursive noise reduction algorithm based on an analysis of the reduction threshold of independent component energy according to random noise elements that are distributed in two or more channels in an Additive White Gaussian Noise (AWGN) reception channel on the basis of sample data having a specific threshold comparison value or higher.

Furthermore, in the present invention, zero padding technology for mapping the signal component of a noise-dependent sample having a correlation or higher to ‘0’ and modified technology, such as an extrapolation or interpolation algorithm, are used.

Furthermore, the noise reduction technology is implemented in an additional frequency domain through parallel processing by performing post-processing on a single channel or multiple channels in the frequency domain using collected signal sample data as shown in FIG. 4.

That is, a frequency domain noise reduction unit 315 shown in FIG. 4 performs correlation processing on each frequency component by way of frequency conversion from a bundle of complex data samples, collected through multiple reception channels or a single reception channel, using time-spatial independency between noise components in a reception signal model, such as Equation 1. In this case, the SNR in a spectrum, that is, in the frequency domain, can be removed by removing random noise components not having a correlation in each frequency component while maintaining signal components having a correlation.

Meanwhile, the sample transmission unit 32 transfers the reception data from which noise has been reduced by the recursive noise reduction algorithm unit 313 to the outside in real time.

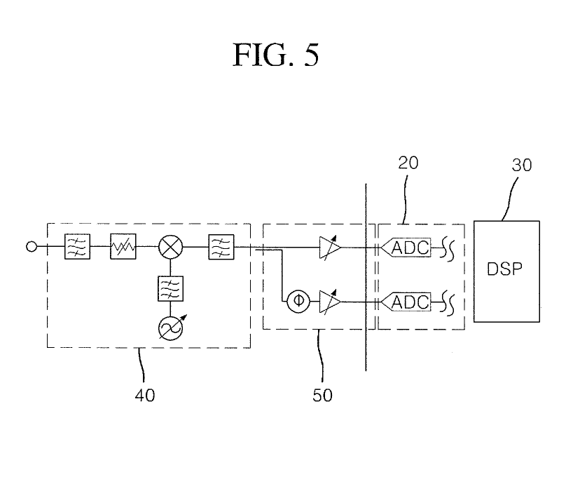

FIG. 5 is a block diagram showing a real-time noise reduction apparatus for a radio monitoring system using a single channel in accordance with another embodiment of the present invention.

Unlike in the aforementioned embodiment, the real-time noise reduction apparatus for a radio monitoring system using a single channel in accordance with another embodiment of the present invention is applied to a frequency down-converter including a single channel. The real-time noise reduction apparatus of the present embodiment includes a channel correction unit 50 for converting signals, received from a single channel frequency down-converter 40, into signals for the two channels, synchronizing the phases of the signals between the two channels, matching the levels of the signals with each other between the two channels, and inputting the resulting signals to the dual channel digitizer 21.

The operations of the dual channel digitizer 21 and the DSP 30 are the same as those of the aforementioned embodiment, and thus a further description thereof is omitted.

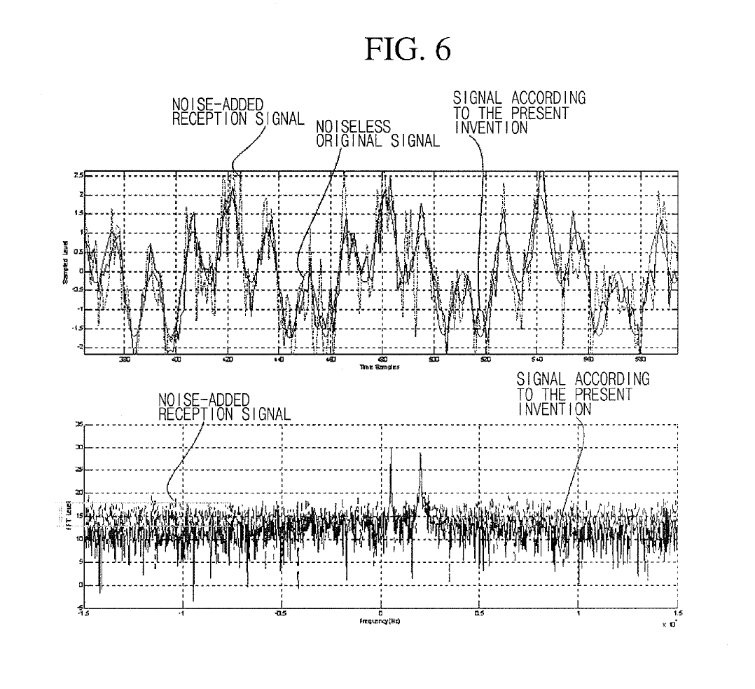

FIG. 6 is a diagram showing results of the operation simulations of the real-time noise reduction apparatus for a radio monitoring system in accordance with an embodiment of the present invention.

Results of the operation simulations of time domain dual channel noise reduction in accordance with an embodiment of the present invention are shown in FIG. 6. From FIG. 6, it can be seen that a noise-added reception signal in which noise has been added to a noiseless original signal having a smooth form results in a noise reduction signal from which noise has been reduced according to the present invention. It can also be seen that the noise reduction part of the noise reduction signal has noise removed as compared with the reception signal and thus the noise reduction part has a signal waveform of a smooth form as compared with the reception signal.

In accordance with the present invention, supplementary and random noise generated in RF reception channels can be reduced by the real-time time domain noise reduction technology using a dual quantization channel, and thus the restoration of a signal component inputted to the RF reception apparatus or the SNR of a reception signal are improved. Accordingly, in radio measurement and radio monitoring technology fields, a weak signal can be detected, and a signal characteristic can be precisely measured.

The embodiments of the present invention have been disclosed above for illustrative purposes. Those skilled in the art will appreciate that various modifications, additions and substitutions are possible, without departing from the scope and spirit of the invention as disclosed in the accompanying claims.

What is claimed is:

1. A real-time noise reduction apparatus for a radio monitoring system, comprising:
a dual channel digitizing unit configured to convert signals, subject to frequency down-conversion and inputted to two channels, into digital signals; and
a Digital Signal Processor (DSP) configured to reduce noise in a time domain using a correlation between samples through feedback, from time sample regions, of the signals received from the dual channel digitizing unit.

2. The real-time noise reduction apparatus of claim 1, wherein the dual channel digitizing unit comprises:
a dual channel digitizer configured to convert the signals, received from the two channels, into the digital signals; and
a clock generation unit configured to provide a sampling clock to the dual channel digitizer.

3. The real-time noise reduction apparatus of claim 2, wherein the clock generation unit generates the sampling clock variably in response to the signals inputted to the two channels.

4. The real-time noise reduction apparatus of claim 2, wherein the dual channel digitizer further comprises a switching unit configured to enable a reference noise level, randomly generated from the two channels, to be used as a reference noise channel for a correlation comparison.

5. The real-time noise reduction apparatus of claim 1, wherein the DSP comprises a noise reduction algorithm processing unit for reducing noise from the signals inputted to the two channels using a time recursive noise reduction algorithm.

6. The real-time noise reduction apparatus of claim 5, wherein the noise reduction algorithm processing unit comprises:
a real-time correlation comparison unit configured to generate a correlation comparison output from time domain samples that are consecutively inputted to the two channels temporally;
correlation determination delay compensation units configured to compensate for a delay of the time domain samples in relation to a processing time of the signals inputted to the two channels; and
a recursive noise reduction algorithm unit configured to perform the time recursive noise reduction algorithm for reducing noise by feeding back an output value obtained from a previous time domain sample of the time domain samples.

7. The real-time noise reduction apparatus of claim 6, wherein the recursive noise reduction algorithm unit performs the time recursive noise reduction algorithm on the time domain samples when a correlation comparison value between the two channels is a threshold parameter or higher as a result of calculating a correlation coefficient between the two channels.

8. The real-time noise reduction apparatus of claim 6, wherein the recursive noise reduction algorithm unit calculates a correlation coefficient between the two channels and transfers one of values inputted to the two channels or a mean of the values inputted to the two channels when a correlation comparison value between the two channels is less than a set threshold parameter or 0 or higher.

9. The real-time noise reduction apparatus of claim 1, further comprising a dual channel frequency down-converter configured to perform frequency down-conversion on the signals inputted to the two channels into signals of a base band so that the signals inputted to the two channels are able to be processed by the dual channel digitizing unit.

10. The real-time noise reduction apparatus of claim 1, further comprising:
a single channel frequency down-converter configured to perform frequency down-conversion on signals received through a single channel from antennas; and
a channel correction unit configured to convert the signals inputted to the single channel frequency down-converter into signals for the two channels, synchronize phases of the signals between the two channels, match levels of the signals with each other between the two channels, and input resulting signals to the dual channel digitizer.
